(19) United States
(12) Patent Application Publication
(10) Pub. No.: US 2024/0396189 A1
(43) Pub. Date: Nov. 28, 2024

(54) SECONDARY BATTERY

(71) Applicant: TOYOTA JIDOSHA KABUSHIKI KAISHA, Toyota-shi (JP)

(72) Inventors: Masahiro ISHIZUKA, Toyota-shi (JP); Kosuke Suzuki, Toyota-shi (JP); Hideto Mori, Nisshin-shi (JP); Mitsuru Tateishi, Toyota-shi (JP); Shinya Ishikawa, Toyota-shi (JP); Mari Tarutani, Nagoya-shi (JP); Kenta Kimura, Toyota-shi (JP); Masato Ono, Nagoya-shi (JP)

(73) Assignee: TOYOTA JIDOSHA KABUSHIKI KAISHA, Toyota-shi (JP)

(21) Appl. No.: 18/630,048

(22) Filed: Apr. 9, 2024

(30) Foreign Application Priority Data
May 24, 2023 (JP) 2023-085301

(51) Int. Cl. H01M 50/655; H01M 50/342; H01M 50/682

(52) U.S. Cl. CPC H01M 50/655; H01M 50/3425; H01M 50/682; H01M 2200/20

(57) ABSTRACT

A secondary battery includes an electrode assembly, a housing, and a positive electrode terminal and a negative electrode terminal provided to the housing. The housing includes a main body with a first opening and a second opening respectively provided on opposite sides in a long-side direction of the housing, a first sealing body that closes the first opening, and a second sealing body that closes the second opening. The main body includes a pair of long-side surfaces and a pair of short-side surfaces facing each other in a short-side direction of the housing orthogonal to the long-side direction. The electrode assembly includes a negative electrode current collecting portion located on a first end side in the long-side direction, and a positive electrode current collecting portion located on a second end side in the long-side direction. One short-side surface of the pair of short-side surfaces is provided with an injection port.

### CROSS REFERENCE TO RELATED APPLICATIONS

This nonprovisional application is based on Japanese Patent Application No. 2023-085301 filed on May 24, 2023 with the Japan Patent Office, the entire contents of which are hereby incorporated by reference.

### BACKGROUND

### Field

The present disclosure relates to secondary batteries, and particularly, to a secondary battery mounted in a vehicle.

### Description of the Background Art

Japanese Patent Application Laying-Open No. 2017-147064 discloses, as a conventional secondary battery, a structure in which an opening of a battery case that is open upward is closed by a lid member, and an injection port is provided in a side surface of the battery case.

### SUMMARY

In recent years, the secondary battery has been demanded to have a higher capacity, leading to a higher ratio of the electrode assembly in the housing. In Japanese Patent Application Laying-Open No. 2017-147064, as the electrode assembly is formed to have a larger size, when the injection port provided in the side surface of the housing faces the side surface of the electrode assembly, the electrolytic solution can be injected into the housing less easily. Further, in Japanese Patent Application Laying-Open No. 2017-147064, the electrode assembly is formed of a wound electrode assembly, and the winding axis of the wound electrode assembly is orthogonal to the direction in which the injection port passes through. This leads to a fear that the ability of impregnating the electrode assembly with the electrolytic solution may decrease.

Along with higher capacity, it is conceivable to form a housing in a longitudinal shape and house the electrode assembly in the housing having the longitudinal shape. In such a case, it is conceivable to close a pair of openings by a pair of sealing bodies such that the opposite sides in the long-side direction are open. When an injection port is provided in each sealing body and the electrolytic solution is injected from the injection port along the long-side direction in the above configuration, a distance for which the electrolytic solution flows along the electrode assembly increases. Thus, it may take time for injection of the electrolytic solution, and the ability of impregnating the electrode assembly with the electrolytic solution may decrease.

The present disclosure has been made in view of the above problem. An object of the present disclosure is to provide a secondary battery that can have improved impregnating ability of an electrolytic solution.

A secondary battery according to the present disclosure includes: an electrode assembly including a positive electrode and a negative electrode disposed side by side in a first direction; a housing that houses the electrode assembly; and a positive electrode terminal and a negative electrode terminal provided to the housing. The housing includes a main body with a first opening and a second opening respectively provided on opposite sides in a long-side direction of the housing which is orthogonal to the first direction, a first sealing body that closes the first opening, and a second sealing body that closes the second opening. The negative electrode terminal is provided to the first sealing body, and the positive electrode terminal is provided to the second sealing body. The main body includes a pair of long-side surfaces facing each other in the first direction, and a pair of short-side surfaces facing each other in a short-side direction of the housing which is orthogonal to the first direction and the long-side direction. The electrode assembly includes a negative electrode current collecting portion located on a first end side in the long-side direction and electrically connected to the negative electrode terminal, and a positive electrode current collecting portion located on a second end side in the long-side direction and electrically connected to the positive electrode terminal. One short-side surface of the pair of short-side surfaces is provided with an injection port.

With the above configuration, the electrolytic solution can be injected into the housing from the injection port provided in one short-side surface toward the short-side direction, thus reducing a distance for which the electrolytic solution flows along the electrode assembly. In addition, the positive electrode and the negative electrode are disposed side by side in the first direction orthogonal to the short-side direction, facilitating impregnation of the electrode assembly with the electrolytic solution. This can improve impregnation ability of the electrolytic solution.

In the secondary battery according to the present disclosure, the one short-side surface may be provided with a plurality of the injection ports.

With the above configuration, the electrolytic solution can be injected from different locations, further facilitating impregnation of the electrode assembly with the electrolytic solution.

In the secondary battery according to the present disclosure, the plurality of injection ports may include a first injection port and a second injection port. In this case, as viewed from the short-side direction, the first injection port may be disposed such that at least a part thereof overlaps with the negative electrode current collecting portion. The second injection port may be disposed such that at least a part thereof overlaps with the positive electrode current collecting portion.

With the above configuration, the negative electrode current collecting portion and the positive electrode current collecting portion have a low density compared with the portion of the electrode assembly on which the positive electrode and the negative electrode are stacked, creating a gap of an appreciable size between the housing and each of the negative electrode current collecting portion and the positive electrode current collecting portion. This can prevent or reduce a leakage of the electrolytic solution out of the housing in injection of the electrolytic solution from the first injection port and the second injection port.

The secondary battery according to the present disclosure may further include a spacer member disposed between the electrode assembly and the one short-side surface. The spacer member may be further provided with a storage portion that stores an electrolytic solution.

With the above configuration, vibrations of the electrode assembly can be prevented or reduced by the spacer member. Also, the electrolytic solution can be stored in the storage portion provided in the spacer member in injection of the electrolytic solution, thus preventing or reducing a leakage of the electrolytic solution out of the housing.

In the secondary battery according to the present disclosure, the one short-side surface may be provided with a single pressure release valve.

With the above configuration, when the pressure release valve is opened, gas can be discharged from the pressure release valve to a preferred direction, that is, a first side in the short-side direction orthogonal to the first direction in which the positive electrode and the negative electrode are disposed side by side. Also, the pressure release valve is provided in the short-side surface different from the first sealing body to which the negative electrode terminal is provided and the second sealing body to which the positive electrode terminal is provided. This can prevent or reduce adhesion of an ejected matter such as an electrolyte solution to an electrode terminal such as the positive electrode terminal and the negative electrode terminal, thereby preventing or reducing unintentional electrical connection between the electrode terminal and a metal member or the like disposed therearound. Thus, the influence of the ejected matter from the pressure release valve on the electrode terminal can be prevented or reduced. In addition, since a single pressure release valve is provided, the location to which gas is discharged can be specified to one location. This can further prevent or reduce an increase in size of the exhaust path for discharging gas from the pressure release valve when a plurality of secondary batteries are disposed side by side compared with a configuration in which a plurality of pressure release valves are provided.

In the secondary battery according to the present disclosure, the pressure release valve may be spaced apart from, in the long-side direction, opposite edges of the one short-side surface in the long-side direction by not less than one third of a length of the one short-side surface in the long-side direction.

With the above configuration, the pressure release valve can be spaced apart from the positive electrode terminal and the negative electrode terminal to an appreciable extent in the long-side direction, further reducing the adhesion of the ejected matter from the pressure release valve to the positive electrode terminal and the negative electrode terminal.

In the secondary battery according to the present disclosure, the pressure release valve may be provided at a central portion of the one short-side surface in the long-side direction.

With the above configuration, the pressure release valve can be disposed at the approximately middle position between the positive electrode terminal and the negative electrode terminal, further reducing the adhesion of the ejected matter from the pressure release valve to the positive electrode terminal and the negative electrode terminal.

In the secondary battery according to the present disclosure, the injection port may be provided with a ventilation film that allows gas to pass therethrough without allowing a liquid to pass therethrough.

With the above configuration, as the outside of the housing is placed under negative pressure and gas generated during charging is discharged out of the housing, the gas can be discharged with the use of the injection port. This eliminates the trouble of separately providing a gas vent port. In addition, a leakage of the electrolytic solution out of the housing can be prevented or reduced by the ventilation film.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view of a secondary battery according to Embodiment 1.

FIG. 2 is an exploded perspective view of the secondary battery according to Embodiment 1.

FIG. 3 is a sectional view taken along the line III-III shown in FIG. 1.

FIG. 4 is a sectional view taken along the line IV-IV shown in FIG. 1.

FIG. 5 is a top view of the secondary battery according to Embodiment 1.

FIG. 6 is a top view of a secondary battery according to Embodiment 2.

FIG. 7 is a sectional view of a secondary battery according to Embodiment 3.

FIG. 8 is a perspective view of a battery module according to Embodiment 4.

### DESCRIPTION OF THE PREFERRED EMBODIMENTS

Embodiments of the present disclosure will be described below in detail with reference to the drawings. In the following description of the embodiments, the same or corresponding portions in the drawings are denoted by the same reference characters, and description thereof will not be repeated.

### Embodiment 1

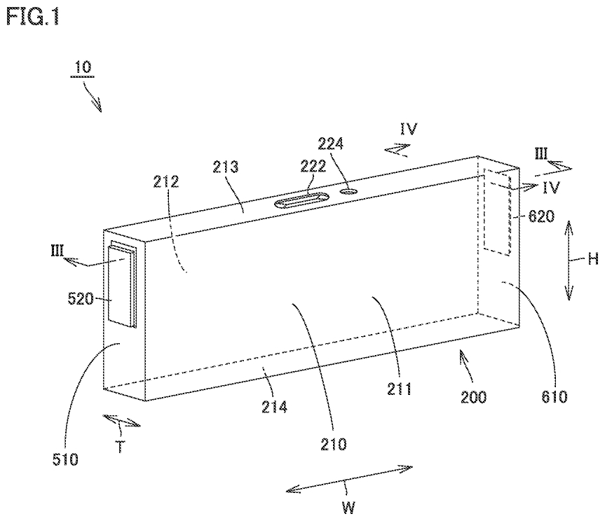

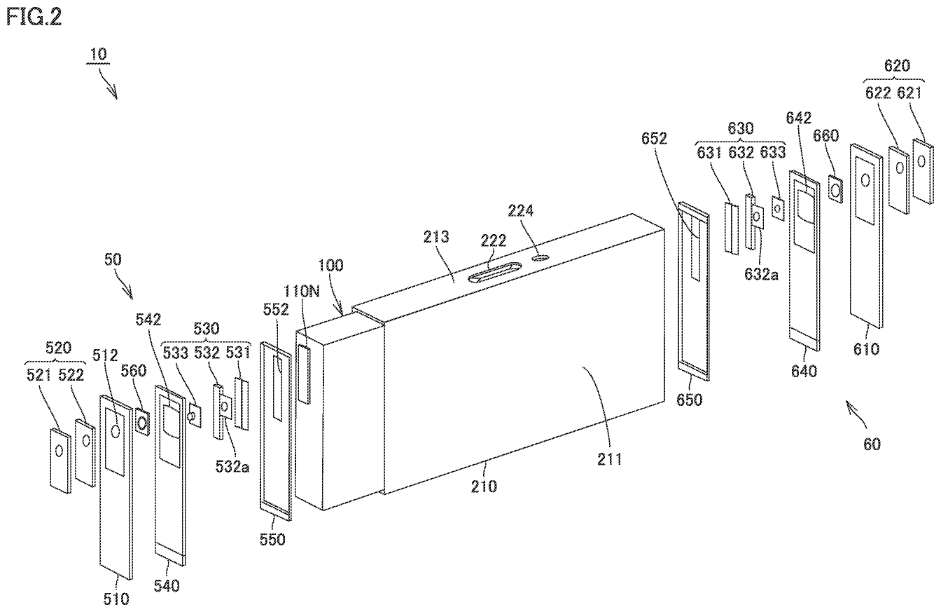

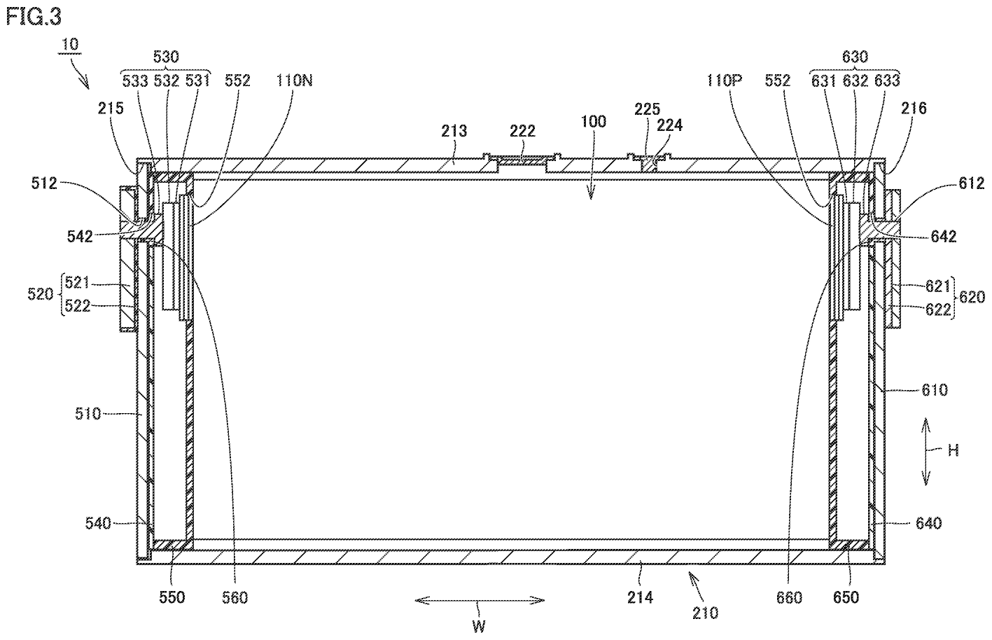

FIG. 1 is a perspective view of a secondary battery according to Embodiment 1. FIG. 2 is an exploded perspective view of the secondary battery according to Embodiment 1. FIG. 3 is a sectional view taken along the line III-III shown in FIG. 1.

As shown in FIGS. 1 to 3, a secondary battery 10 according to Embodiment 1 includes an electrode assembly 100, a housing 200, a positive electrode member 620 as a positive electrode terminal, and a negative electrode member 520 as a negative electrode terminal.

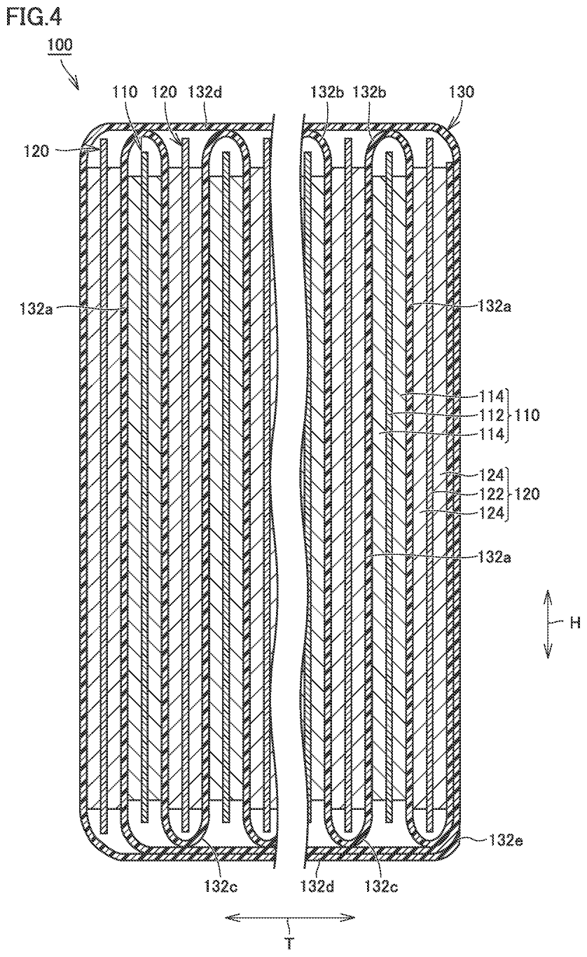

Housing 200 has a rectangular parallelepiped shape with a thickness in a thickness direction T smaller than a width in a width direction W and a height in a height direction H. Thickness direction T is parallel to a first direction in which positive electrodes 110 (see FIG. 4) and negative electrodes 120 (see FIG. 4), which will be described later, are disposed side by side. Width direction W is orthogonal to thickness direction T, and height direction H is orthogonal to thickness direction T and width direction W. The width of housing 200 in width direction W is greater than the height of housing 200 in height direction H. Width direction W is defined as a long-side direction of housing 200, and height direction H is defined as a short-side direction of housing 200.

Housing 200 houses electrode assembly 100 and an electrolyte solution (not shown). Housing 200 includes a main body 210, a first sealing body 510, and a second sealing body 610.

Main body 210 has a cylindrical shape with first opening 215 and second opening 216 respectively provided on the opposite sides in width direction W. More particularly, main body 210 has a quadrangular cylindrical shape that is open on the opposite sides in width direction W. First opening 215 is provided on a first side in width direction W, and second opening 216 is provided on a second side in width direction W. Main body 210 is made of a metal such as aluminum.

Main body 210 includes a pair of long-side surfaces 211, 212 facing each other in thickness direction T and a pair of short-side surfaces 213, 214 facing each other in height direction H. Short-side surface 213 of the pair of short-side surfaces 213, 214 is located on a first side (upper side) in height direction H. Short-side surface 213 connects the edges of the pair of long-side surfaces 211, 212 located on the first side in height direction H. Short-side surface 214 is located on a second side (lower side) in height direction H. Short-side surface 214 connects the edges of the pair of long-side surfaces 211, 212 located on the second side in height direction H.

Short-side surface 213 is provided with a pressure release valve 222 and an injection port 224. Pressure release valve 222 is a pressure release valve provided to rupture when the internal pressure of housing 200 becomes greater than or equal to a predetermined pressure. As pressure release valve 222 ruptures, gas in housing 200 is discharged out of housing 200, reducing the internal pressure in housing 200.

Injection port 224 is sealed with a sealing member 225. Injection port 224 is a through hole for injecting an electrolyte solution into housing 200 in the process of manufacturing secondary battery 10. Sealing member 225 is a member that seals injection port 224 after the injection of the electrolyte solution into housing 200. Sealing member 225 may be, for example, a ventilation film that allows gas to pass therethrough without allowing a liquid to pass therethrough. In this case, when gas generated during charging is discharged out of housing 200, the gas can be discharged through the ventilation film. This eliminates the trouble of separately providing a gas vent port. In addition, a leakage of the electrolyte solution out of housing 200 can be prevented or reduced by the ventilation film. Sealing member 225 is not limited to the ventilation film and may be a resin member, a metal member, or any other member as appropriate.

First sealing body 510 closes first opening 215. First sealing body 510 has a flat plate shape. First sealing body 510 is made of a metal such as aluminum. Negative electrode member 520 is provided to first sealing body 510. First sealing body 510 is fixed to first opening 215 by, for example, laser welding or the like.

Negative electrode member 520 is provided on the outer surface of first sealing body 510. Negative electrode member 520 functions as a negative electrode terminal. Negative electrode member 520 includes a negative electrode terminal plate 521 and an insulating plate 522.

Negative-electrode terminal plate 521 is formed in an approximately rectangular parallelepiped shape. Negative electrode terminal plate 521 is held by insulating plate 522. Insulating plate 522 is fixed to the outer surface of first sealing body 510. Insulating plate 522 insulates first sealing body 510 from negative electrode terminal plate 521. Each of negative electrode terminal plate 521 and insulating plate 522 has a through hole for causing a negative electrode coupling pin 533, which will be described later, to pass therethrough.

Second sealing body 610 closes second opening 216. Second sealing body 610 has a flat plate shape. Second sealing body 610 is made of a metal such as aluminum. Positive electrode member 620 is provided to second sealing body 610. Second sealing body 610 is fixed to second opening 216 by, for example, laser welding or the like.

Positive electrode member 620 is provided on the outer surface of second sealing body 610. Positive electrode member 620 functions as a positive electrode terminal. Positive electrode member 620 includes a positive electrode terminal plate 621 and a terminal block 622.

Positive electrode terminal plate 621 is formed in an approximately rectangular parallelepiped shape. Positive electrode terminal plate 621 is made of a metal such as aluminum.

Terminal block 622 is formed in a rectangular parallelepiped shape. Terminal block 622 is made of a material (e.g., iron) different from the material for positive electrode terminal plate 621. Terminal block 622 is fixed to the outer surface of second sealing body 610 by welding or the like. Positive electrode terminal plate 621 is fixed to terminal block 622 by welding or the like. Main body 210 and second sealing body 610 are electrically connected to positive electrode terminal plate 621 via terminal block 622 and are charged with the same polarity as that of positive electrode terminal plate 621. Each of positive electrode terminal plate 621 and terminal block 622 has a through hole for causing a positive electrode coupling pin 633, which will be described later, to pass therethrough.

An insulating plate may be disposed between positive electrode member 620 and second sealing body 610, so that positive electrode member 620 is electrically insulated from second sealing body 610. In this case, the insulating plate may be disposed in place of terminal block 622, or the insulating plate may be disposed between terminal block 622 and second sealing body 610.

Secondary battery 10 further includes a negative electrode coupling member 530, a first negative-electrode-side insulating member 540, a second negative-electrode-side insulating member 550, and an insulator 560 on the negative electrode member 520 side.

Negative electrode coupling member 530 couples a negative electrode current collecting portion 110N to a negative electrode terminal plate 521. Negative electrode current collecting portion 110N is a portion of electrode assembly 100 which is formed of a bundle of a plurality of negative electrode tabs 122n (see FIG. 5), which will be described later. Negative electrode coupling member 530 includes a first negative-electrode-side current collector 531, a second negative-electrode-side current collector 532, and negative electrode coupling pin 533.

First negative-electrode-side current collector 531 is formed of a thin-plate-shaped conductive member. First negative-electrode-side current collector 531 is connected to negative electrode current collecting portion 110N by laser welding, ultrasonic welding, or the like.

Second negative-electrode-side current collector 532 is formed of a thin-plate-shaped conductive member. Second negative-electrode-side current collector 532 is connected to first negative-electrode-side current collector 531 by laser welding, ultrasonic welding, or the like. Second negative-electrode-side current collector 532 includes a holding portion 532a that holds negative electrode coupling pin 533. Holding portion 532a has a flat plate shape. Holding portion 532a has a through hole, into which the proximal end of negative electrode coupling pin 533 is inserted.

Negative electrode coupling pin 533 couples second negative-electrode-side current collector 532 to negative electrode terminal plate 521. Negative electrode coupling pin 533 includes a columnar portion. The distal side of the columnar portion passes through first sealing body 510, insulating plate 522, and negative electrode terminal plate 521 and is crimped onto negative electrode terminal plate 521.

First negative-electrode-side insulating member 540 has an approximately plate shape. First negative-electrode-side insulating member 540 is disposed to be in contact with the inner surface of first sealing body 510. First negative-electrode-side insulating member 540 has a through hole 542 into which negative electrode coupling pin 533 is inserted.

Second negative-electrode-side insulating member 550 is disposed between first negative-electrode-side insulating member 540 and electrode assembly 100. Second negative-electrode-side insulating member 550 has a slit 552, into which negative electrode current collecting portion 110N is inserted.

First negative-electrode-side insulating member 540 and second negative-electrode-side insulating member 550 are assembled to define an accommodation space therebetween. Negative electrode current collecting portion 110N inserted into slit 552, first negative-electrode-side current collector 531, and second negative-electrode-side current collector 532 are disposed in the accommodation space.

Insulator 560 is shaped to cover the columnar portion of negative electrode coupling pin 533. Insulator 560 insulates negative electrode coupling pin 533 from housing 200 (more particularly, first sealing body 510).

Negative electrode member 520, first sealing body 510, negative electrode coupling member 530, first negative-electrode-side insulating member 540, second negative-electrode-side insulating member 550, and insulator 560 are assembled to constitute a first lid assembly 50.

As first sealing body 510 is attached to first opening 215 with negative electrode current collecting portion 110N and negative electrode coupling member 530 fixed by welding or the like, first lid assembly 50 is fixed to main body 210. Secondary battery 10 further includes a positive electrode coupling member 630, a first positive-electrode-side insulating member 640, a second positive-electrode-side insulating member 650, and an insulator 660 on the positive electrode member 620 side.

Positive electrode coupling member 630 couples a positive electrode current collecting portion 110P to positive electrode terminal plate 621. Positive electrode current collecting portion 110P is a portion of electrode assembly 100 which is formed of a bundle of a plurality of positive electrode tabs 112p (see FIG. 5), which will be described later. Positive electrode coupling member 630 includes a first positive-electrode-side current collector 631, a second positive-electrode-side current collector 632, and a positive electrode coupling pin 633.

First positive-electrode-side current collector 531 is formed of a thin-plate-shaped conductive member. First positive-electrode-side current collector 531 is connected to positive electrode current collecting portion 110P by laser welding, ultrasonic welding, or the like.

Second positive-electrode-side current collector 632 is formed of a thin-plate-shaped conductive member. Second positive-electrode-side current collector 632 is connected to first positive-electrode-side current collector 631 by laser welding, ultrasonic welding, or the like. Second positive-electrode-side current collector 632 includes a holding portion 632a that holds positive electrode coupling pin 633. Holding portion 632a has a flat plate shape. Holding portion 632a has a through hole, into which the proximal end of positive electrode coupling pin 633 is inserted.

Positive electrode coupling pin 633 couples second positive-electrode-side current collector 632 to positive electrode terminal plate 621. Positive electrode coupling pin 633 includes a columnar portion. The distal side of the columnar portion passes through second sealing body 610, terminal block 622, and positive electrode terminal plate 621 and is crimped onto positive electrode terminal plate 621.

First positive-electrode-side insulating member 640 has an approximately plate shape. First positive-electrode-side insulating member 640 is disposed to be in contact with the inner surface of second sealing body 610. First positive-electrode-side insulating member 640 has a through hole 642, into which positive electrode coupling pin 633 is inserted.

Second positive-electrode-side insulating member 650 is disposed between first positive-electrode-side insulating member 640 and electrode assembly 100. Second positive-electrode-side insulating member 650 has a slit 652, into which positive electrode current collecting portion 110P is inserted.

First positive-electrode-side insulating member 540 and second positive-electrode-side insulating member 550 are assembled to define an accommodation space therebetween. Positive electrode current collecting portion 110P inserted into slit 552, first positive-electrode-side current collector 631, and second positive-electrode-side current collector 632 are disposed in the accommodation space.

Insulator 660 is shaped to cover the columnar portion of positive electrode coupling pin 633. Insulator 660 insulates positive electrode coupling pin 633 from housing 200 (more particularly, second sealing body 610).

Positive electrode member 620, second sealing body 610, positive electrode coupling member 630, first positive-electrode-side insulating member 640, second positive-electrode-side insulating member 650, and insulator 660 are assembled to constitute a second lid assembly 60.

As second sealing body 610 is attached to second opening 216 with positive electrode current collecting portion 110P and positive electrode coupling member 630 fixed by welding or the like, second lid assembly 60 is fixed to main body 210.

FIG. 4 is a sectional view taken along the line IV-IV shown in FIG. 1. For convenience, FIG. 4 does not show housing 200 of secondary battery 10 and shows only electrode assembly 100. The details of electrode assembly 100 will be described with reference to FIG. 4.

As shown in FIG. 4, electrode assembly 100 includes positive electrodes 110, negative electrodes 120, and a separator 130. Positive electrodes 110 and negative electrodes 120 are disposed side by side alternately in thickness direction T while being insulated from each other by separator 130.

Each negative electrode 120 is formed in a rectangular shape with a long side in width direction W and a short side in height direction H. Each negative electrode 120 includes a negative electrode current collecting foil 122, and negative electrode active material layers 124 provided on the opposite surfaces of negative electrode current collecting foil 122. As shown in FIG. 4, negative electrode current collecting foil 122 includes negative electrode tab 122n (see FIG. 5) in which negative electrode active material layers 124 are not provided. Negative electrode tab 122n projects to the first side in width direction W.

Each positive electrode 110 is formed in a rectangular shape with a long side in width direction W and a short side in height direction H. Each positive electrode 110 includes a positive electrode current collecting foil 112, and positive electrode active material layers 114 provided on the opposite surfaces of positive electrode current collecting foil 112 in thickness direction T. Positive electrode current collecting foil 112 includes a positive electrode tab 112p (see FIG. 5) in which positive electrode active material layer 114 is not provided. Positive electrode tab 112p projects to the second side in width direction W.

Separator 130 insulates positive electrode 110 from negative electrode 120. Separator 130 is made of an insulating material and has minute air gaps that allow ions to pass therethrough. Separator 130 is formed in a zigzag manner.

Separator 130 takes on a rectangular shape before being formed in a zigzag manner. Separator 130 is disposed while being formed in a zigzag manner between positive electrode 110 and negative electrode 120. Separator 130 includes a plurality of intervening portions 132a, a plurality of first folded portions 132b, a plurality of second folded portions 132c, and an outermost covering portion 132d.

Each intervening portion 132a is provided between positive electrode 110 and negative electrode 120 adjacent to each other in thickness direction T. In other words, each intervening portion 132a has a function to insulate positive electrode 110 from negative electrode 120. Each intervening portion 132a is formed in a rectangular region.

Each first folded portion 132b couples the first-side ends in height direction H of intervening portions 132a adjacent to each other in thickness direction T such that positive electrode 110 is located therebetween. First folded portion 132b is disposed on the first side (upper side) in height direction H of positive electrode 110.

Each second folded portion 132c couples the second-side ends in height direction H of intervening portions 132a adjacent to each other in thickness direction T such that negative electrode 120 is located therebetween. Second folded portion 132c is disposed on the second side (lower side) in height direction H of negative electrode 120.

Outermost covering portion 132d covers first folded portions 132b and second folded portions 132c together. More specifically, outermost covering portion 132d covers all positive electrodes 110, all negative electrodes 120, all intervening portions 132a, all first folded portions 132b, and all second folded portions 132c together while winding about the central axis parallel to width direction W. A terminal end 132e of outermost covering portion 132d is set so as not to overlap positive electrode active material layer 114 and negative electrode active material layer 124 in thickness direction T. In the present embodiment, terminal end 132e of outermost covering portion 132d is disposed below positive electrodes 110 and negative electrodes 120. The peripheral surfaces and the bottoms of positive electrodes 110, negative electrodes 120, and separator 130 may be covered with an insulating film (not shown).

FIG. 5 is a top view of a secondary battery according to Embodiment 1. Referring to FIG. 5, the details of the disposition of a pressure release valve and an injection port will be described.

As shown in FIG. 5, pressure release valve 222 and injection port 224 are provided in short-side surfaces 213. More particularly, pressure release valve 222 is spaced apart from, in width direction W, the opposite edges of short-side surface 213 in width direction W by not less than one third of the length of short-side surface 213 in width direction W.

In other words, when short-side surface 213 is equally divided into three, that is, a first region R1, a second region R2, and a third region R3 in order from the first side in width direction W, pressure release valve 222 is provided in second region R2 located between first region R1 and third region R3.

Thus, pressure release valve 222 can be spaced apart from positive electrode member 620 and negative electrode member 520 in width direction W to an appreciable extent, thereby reducing adhesion of an ejected matter from pressure release valve 222 to positive electrode member 620 and negative electrode member 520.

Injection port 224 is also provided in second region R2. Thus, in injection of the electrolyte solution from injection port 224, the electrolyte solution can be spread more uniformly into housing 200 than when injection port 224 is provided only in first region R1 and when injection port 224 is provided only in third region R3.

In secondary battery 10 according to the present embodiment, the electrolytic solution can be injected into housing 200 from injection port 224 provided in short-side surface 213 toward the short-side direction, thereby reducing a distance for which the electrolytic solution flows along the electrode assembly. In addition, positive electrode 110 and negative electrode 120 are disposed side by side in the first direction orthogonal to the short-side direction, thus facilitating impregnation of electrode assembly 100 with the electrolytic solution from the end sides of positive electrode 110 and negative electrode 120 located on the first side in the short-side direction. This leads to improved impregnating ability of the electrolytic solution.

Further, in secondary battery 10 according to the present embodiment, negative electrode member 520 and positive electrode member 620 are provided to first sealing body 510 and second sealing body 610, respectively, that are disposed while facing each other in the long-side direction (width direction W). Also, pressure release valve 222 is provided in short-side surface 213 of housing 200 which is located on the first side in the short-side direction (height direction H) orthogonal to the long-side direction. In other words, in housing 200, pressure release valve 222 is provided in the surface different from the surfaces on which negative electrode member 520 and positive electrode member 620 are provided. Thus, as described above, when an ejected matter such as gas or an electrolyte solution is ejected from pressure release valve 222, adhesion of the ejected matter to an electrode terminal such as negative electrode member 520 and positive electrode member 620 can be prevented or reduced, thereby preventing or reducing unintentional electrical connection between the electrode terminal and a metal member or the like disposed therearound. This can prevent or reduce the influence of the ejected matter from the pressure release valve on the electrode terminal.

Short-side surface 213 is provided with a single pressure release valve 222, and accordingly, the direction in which an ejected matter is ejected from pressure release valve 222 can be specified to a preferred direction. Also, when a power storage module is formed of a plurality of secondary batteries 10 disposed side by side, as each secondary battery 10 is provided with a single pressure release valve 222, an increase in size of an exhaust path for exhausting gas discharged from the pressure release valve can be further prevented or reduced compared with the configuration in which each secondary battery is provided with a plurality of pressure release valves.

In addition, negative electrode member 520 and positive electrode member 620 are provided in first sealing body 510 and second sealing body 610, respectively. Such a configuration can have a lower height than the configuration in which negative electrode member 520 and positive electrode member 620 are provided on short-side surface 213.

### Embodiment 2

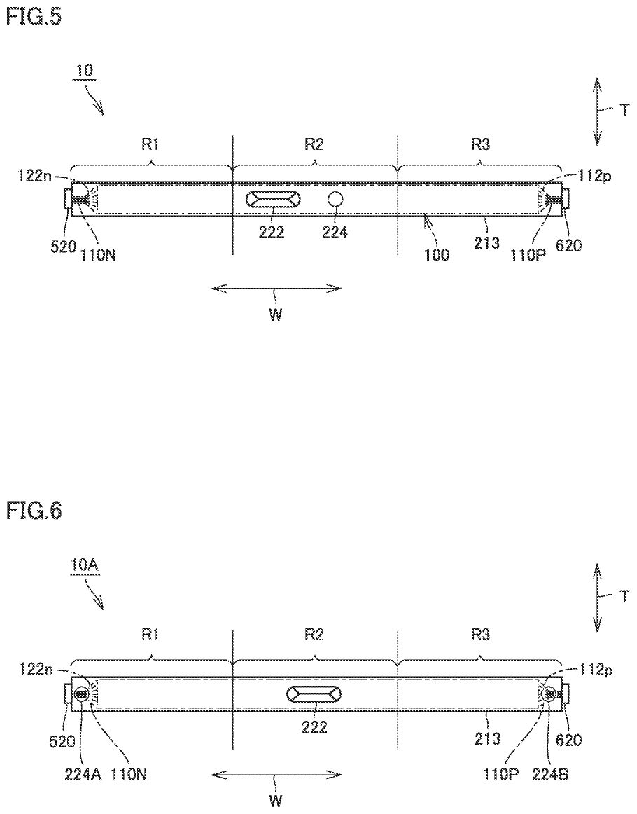

FIG. 6 is a top view of a secondary battery according to Embodiment 2. A secondary battery 10A according to Embodiment 2 will be described with reference to FIG. 6.

As shown in FIG. 6, secondary battery 10A according to Embodiment 2 is different from secondary battery 10 according to Embodiment 1 in the disposition of pressure release valve 222 and the provision of injection ports. The other configuration is substantially the same.

Pressure release valve 222 is provided in width direction W at the central portion of short-side surface 213. In the central portion, a manufacturing error such as tolerance is taken into account.

The plurality of injection ports include a first injection port 224A and a second injection port 224B. First injection port 224A is provided in first region R1. First injection port 224A is provided on the first side in width direction W in short-side surface 213. Specifically, first injection port 224A is disposed such that at least a part thereof overlaps with negative electrode current collecting portion 110N in height direction H.

Second injection port 224B is provided in third region R3. Second injection port 224B is provided on a second side in width direction W in short-side surface 213. Specifically, second injection port 224B is disposed such that at least a part thereof overlaps with positive electrode current collecting portion 110P in height direction H.

Also in the case of the configuration above, secondary battery 10A according to Embodiment 2 can achieve substantially similar effects to those of secondary battery 10 according to Embodiment 1.

In addition, as a plurality of injection ports (first injection port 224A, second injection port 224B) are provided in short-side surface 213, the electrolyte solution can be injected into housing 200 from a plurality of locations. Consequently, electrode assembly 100 is impregnated with the electrolytic solution more easily.

Further, first injection port 224A and second injection port 224B are disposed such that at least parts thereof overlap with negative electrode current collecting portion 110N and positive electrode current collecting portion 110P, respectively, in height direction H. Negative electrode current collecting portion 110N is a portion of electrode assembly 100 in which negative electrode tabs 122n are collected, and positive electrode current collecting portion 110P is a portion of electrode assembly 100 in which positive electrode tabs 112p are collected. Thus, negative electrode current collecting portion 110N and positive electrode current collecting portion 110P have a low density compared with the portions of electrode assembly 100 in which positive electrodes 110 and negative electrodes 120 are stacked, and a gap of an appreciable size is present between housing 200 and each of negative electrode current collecting portion 110N and positive electrode current collecting portion 110P. This can prevent or reduce a leakage of the electrolytic solution toward housing 200 in injection of the electrolytic solution from first injection port 224A and second injection port 224B.

Also, pressure release valve 222 is disposed at an approximately middle position between positive electrode member 620 and negative electrode member 520, thereby further reducing adhesion of the ejected matter from pressure release valve 222 to positive electrode member 620 and negative electrode member 520.

### Embodiment 3

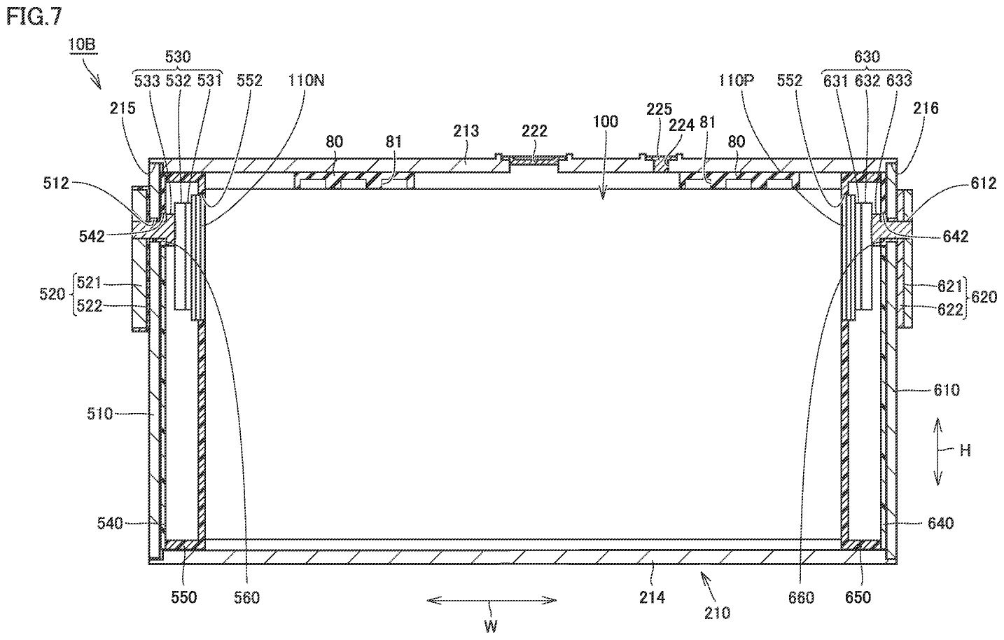

FIG. 7 is a sectional view of a secondary battery according to Embodiment 3. FIG. 7 is a sectional view corresponding to FIG. 3. Referring to FIG. 7, a secondary battery 10B according to Embodiment 3 will be described.

As shown in FIG. 7, secondary battery 10B according to Embodiment 3 is different from secondary battery 10 according to Embodiment 1 in that it includes a spacer member 80. The other configuration is substantially similar.

Spacer member 80 is disposed between short-side surface 213 and electrode assembly 100. Spacer member 80 may be formed of an elastic body such as urethane rubber or may be formed of a resin member. Spacer member 80 functions as a buffering member and prevents or reduces vibrations of electrode assembly 100. Spacer member 80 is sandwiched between short-side surface 213 and electrode assembly 100. Spacer member 80, which has insulating properties, insulates short-side surface 213 from electrode assembly 100.

Spacer member 80 is provided with a storage portion 81 that can store the electrolytic solution. Storage portion 81 is provided to communicate with the interior space of housing 200. Storage portion 81 is formed of, for example, a lightened portion. Storage portion 81 may be provided to pass through spacer member 80 in height direction H.

Also in the case of the above configuration, secondary battery 10B according to Embodiment 3 can achieve substantially similar effects to those of secondary battery 10 according to Embodiment 1.

In addition, vibrations of electrode assembly 100 can be prevented or reduced by spacer member 80. Further, the electrolytic solution can be stored in storage portion 81 provided in spacer member 80 in injection of the electrolytic solution, thus preventing or reducing a leakage of the electrolytic solution out of housing 200.

### Embodiment 4

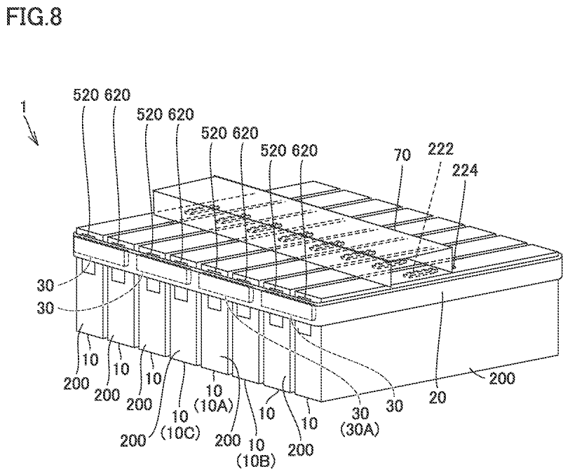

FIG. 8 is a perspective view of a battery module according to Embodiment 4. Referring to FIG. 8, a battery module 1 according to Embodiment 4 will be described.

As shown in FIG. 8, battery module 1 according to Embodiment 3 is formed of a plurality of secondary batteries 10 according to Embodiment 1 which are disposed side by side. Battery module 1 includes secondary batteries 10, a band 20, a plurality of bus-bars 30, and an exhaust path formation member 70.

Secondary batteries 10 are disposed side by side in thickness direction T. A spacer may be disposed between secondary batteries 10 adjacent to each other in thickness direction T. Secondary batteries 10 are disposed such that positive electrode members 620 and negative electrode members 520 are disposed alternately in thickness direction T on each of the first side and the second side in width direction W. Secondary batteries 10 are disposed such that pressure release valves 222 are disposed side by side in thickness direction T approximately linearly.

Bus-bars 30 are made of a metal such as aluminum or an aluminum alloy. Bus-bars 30 connect positive electrode members 620 (more particularly, positive electrode terminal plates 621) and negative electrode members 520 (more particularly, negative electrode terminal plates 521) of secondary batteries 10 adjacent to each other such that secondary batteries 10 are connected in series.

Band 20 is provided annularly and surrounds secondary batteries 10. Band 20 is disposed to be in close contact with bus-bars 30. Band 20 is disposed to cover, while abutting, bus-bars 30. Band 20 is stretchable. Band 20 restrains secondary batteries 10 by a contraction force when surrounding secondary batteries 10. The material for band 20 is not particularly limited and may be, for example, an elastic member such as silicone rubber.

Exhaust path formation member 70 is provided to cover pressure release valves 222. Exhaust path formation member 70 is formed of a cover member. Exhaust path formation member 70 is shaped to run linearly in thickness direction T at portions located above secondary batteries 10.

Battery module 1 according to the present embodiment, which has a configuration in which secondary batteries 10 each including a single pressure release valve 222 are disposed side by side, can have a simple configuration of exhaust path formation member 70 for exhausting gas discharged from the pressure release valve compared with the configuration in which a plurality of pressure release valves are provided in each secondary battery, thus preventing or reducing an increase in size of the exhaust path.

Also, in the present embodiment, positive electrode member 620 and negative electrode member 520 are connected by bus-bar 30 from outside in width direction W on each of the first side and the second side in the width direction W of secondary batteries 10 disposed side by side in thickness direction T. Consequently, battery module 1 can have a low height compared with the configuration in which the positive electrode member and the negative electrode member provided on short-side surfaces 213 on the first side (upper side) in the height direction are connected by a bus-bar from the first side in the height direction.

Further, since stretchable band 20 can be attached to secondary batteries 10 from height direction H, the workability for restraining secondary batteries 10 can be improved.

For battery module 1 according to Embodiment 3, though the case in which secondary batteries 10 according to Embodiment 1 are disposed side by side has been described as an example, the present disclosure is not limited thereto, and secondary batteries 10A according to Embodiment 2 or secondary batteries 10B according to Embodiment 3 may be disposed side by side.

Embodiments 1 to 4 have described, by way of example, the case in which the first side in height direction H is the upper side in the vertical direction, but the present disclosure is not limited thereto. The first side in height direction H may be the lower side in the vertical direction. In this case, exhaust path formation member 70 may be disposed below secondary batteries 10 in Embodiment 4.

Although the embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A secondary battery comprising:
an electrode assembly including a positive electrode and a negative electrode disposed side by side in a first direction;
a housing that houses the electrode assembly; and
a positive electrode terminal and a negative electrode terminal provided to the housing, wherein
the housing includes
a main body with a first opening and a second opening respectively provided on opposite sides in a long-side direction of the housing, the long-side direction being orthogonal to the first direction,
a first sealing body that closes the first opening, and
a second sealing body that closes the second opening,
the negative electrode terminal is provided to the first sealing body,
the positive electrode terminal is provided to the second sealing body,
the main body includes
a pair of long-side surfaces facing each other in the first direction, and
a pair of short-side surfaces facing each other in a short-side direction of the housing, the short-side direction being orthogonal to the first direction and the long-side direction,
the electrode assembly includes
a negative electrode current collecting portion located on a first end side in the long-side direction and electrically connected to the negative electrode terminal, and
a positive electrode current collecting portion located on a second end side in the long-side direction and electrically connected to the positive electrode terminal, and
one short-side surface of the pair of short-side surfaces is provided with an injection port.

2. The secondary battery according to claim 1, wherein the one short-side surface is provided with a plurality of the injection ports.

3. The secondary battery according to claim 2, wherein
the plurality of injection ports include a first injection port and a second injection port, and
as viewed from the short-side direction, the first injection port is disposed such that at least a part thereof overlaps with the negative electrode current collecting portion, and the second injection port is disposed such that at least a part thereof overlaps with the positive electrode current collecting portion.

4. The secondary battery according to claim 3, further comprising a spacer member disposed between the electrode assembly and the one short-side surface,
wherein the spacer member is provided with a storage portion that stores an electrolytic solution.

5. The secondary battery according to claim 1, wherein the one short-side surface is provided with a single pressure release valve.

6. The secondary battery according to claim 5, wherein the pressure release valve is spaced apart from, in the long-side direction, opposite ends of the one short-side surface in the long-side direction by not less than one third of a length of the one short-side surface in the long-side direction.

7. The secondary battery according to claim 6, wherein the pressure release valve is provided at a central portion of the one short-side surface in the long-side direction.

8. The secondary battery according to claim 1, wherein the injection port is provided with a ventilation film that allows gas to pass therethrough without allowing a liquid to pass therethrough.
